(19) United States
(12) Patent Application Publication
(10) Pub. No.: US 2026/0274044 A1
(43) Pub. Date: Sep. 17, 2026

(54) ELECTRIC COMPRESSOR

(71) Applicant: SANDEN CORPORATION, Isesaki-shi, Gunma (JP)

(72) Inventors: Atsuo TESHIMA, Isesaki-shi, Gunma (JP); Tatsuhito INOUE, Isesaki-shi, Gunma (JP)

(21) Appl. No.: 19/165,126

(22) PCT Filed: Jul. 16, 2024
(86) PCT No.: PCT/JP2024/025417

§ 371 Date: Sep. 14, 2025

(30) Foreign Application Priority Data
Aug. 23, 2023 (JP) 2023-131341

(51) Int. Cl. B60H 1/32; B60H 1/00; H02K 5/04; H02K 5/24; H02K 11/33; H02K 21/14

(52) U.S. Cl. CPC B60H 1/3226; B60H 1/00507; H02K 5/04; H02K 5/24; H02K 11/33; H02K 21/14; B60H 2001/006; B60H 2001/3292

(57) ABSTRACT

An electric compressor includes an electric motor, a compression mechanism configured to be driven by the electric motor, an inverter configured to drive the electric motor, a motor housing configured to accommodate the electric motor, and an inverter case abutting on and fixed to the motor housing, the inverter case being configured to accommodate the inverter. The motor housing includes a tubular main body portion, and a first protruding portion provided on an outer peripheral surface of the main body portion. The inverter case includes an end wall, and an outer surface of the end wall includes an abutment portion that abuts on one end surface of the main body portion, and an exposed portion exposed to the outside. The exposed portion is provided with a second protruding portion. The first protruding portion is directly or indirectly fixed to the second protruding portion.

### TECHNICAL FIELD

The present invention relates to an electric compressor.

### BACKGROUND ART

Many electric compressors used to compress a refrigerant in a vehicle air-conditioning apparatus include an electric motor that drives a compression mechanism, and an inverter. In addition, power supply to the electric motor is controlled while direct current power from, for example, a vehicle-mounted battery is converted by the inverter to alternating current power, and therefore, the electric motor is driven. In this regard, Patent Literature 1 discloses that a motor housing that accommodates an electric motor and an inverter case that accommodates an inverter are brought into contact with each other in an axial direction of an electric compressor and are fixed together.

### CITATION LIST

### Patent Literature

Patent Literature 1: JP-A-2022-138248

### SUMMARY OF INVENTION

### Problems to be Solved by Invention

In recent years, the voltage of electric vehicles has been increased. With increasing voltage, the size of an electronic board of the inverter has been increased in order to secure an insulation distance at high voltages, and as a result, the size of the inverter case has also been increased. Hence, as viewed in the axial direction of the electric compressor, the inverter case protrudes greatly from the outline of the motor housing. The protruding portion of the inverter case has low flexural rigidity and a low natural frequency. Therefore, resonance may occur during operation of the electric compressor. Note that this resonance may cause damage to the inverter.

Hence, an object of the present invention is to suppress occurrence of resonance in an inverter case during operation of an electric compressor.

### Solution to Problems

According to one aspect of the present invention, an electric compressor is provided. The electric compressor includes: an electric motor; a compression mechanism configured to be driven by the electric motor; an inverter configured to drive the electric motor; a motor housing configured to accommodate the electric motor; and an inverter case abutting on and fixed to the motor housing, the inverter case being configured to accommodate the inverter. The motor housing includes a tubular main body portion, and a first protruding portion provided on an outer peripheral surface of the main body portion. The inverter case includes an end wall. An outer surface of the end wall includes an abutment portion that abuts on one end surface of the main body portion, and an exposed portion exposed to the outside. The exposed portion of the outer surface of the end wall is provided with a second protruding portion. The first protruding portion is directly or indirectly fixed to the second protruding portion.

### Effects of Invention

According to the present invention, it is possible to suppress occurrence of resonance in an inverter case during operation of an electric compressor.

### BRIEF DESCRIPTION OF DRAWINGS

FIG. 1 is a schematic vertical cross-sectional view of an electric compressor in a first embodiment of the present invention.

FIG. 2 is a view on arrows A-A of FIG. 1.

FIG. 3 is a front view of the electric compressor in the first embodiment.

FIG. 4 is a bottom view of the electric compressor in the first embodiment.

FIG. 5 is a front view of a motor housing in the first embodiment.

FIG. 6 is a perspective view of a coupling member in the first embodiment.

FIG. 7 is a perspective view of a coupling member in a second embodiment of the present invention.

FIG. 8 is a perspective view of a coupling member in a third embodiment of the present invention.

FIG. 9 is a perspective view of a coupling member in a fourth embodiment of the present invention.

FIG. 10 is a diagram illustrating an attached state of the coupling member as viewed from the rear in the fourth embodiment.

FIG. 11 is a diagram illustrating the attached state of the coupling member as viewed from below in the fourth embodiment.

FIG. 12 is a diagram for explaining a rotation stop function of the coupling member in the fourth embodiment.

FIG. 13 is a schematic vertical cross-sectional view of an electric compressor in a fifth embodiment of the present invention.

FIG. 14 is a view on arrows B-B of FIG. 13.

FIG. 15 is a bottom view of the electric compressor in the fifth embodiment.

FIG. 16 is a diagram illustrating a modification of the electric compressor of the fifth embodiment.

FIG. 17 is a left side view of an electric compressor in a sixth embodiment of the present invention.

FIG. 18 is a schematic vertical cross-sectional view of the electric compressor in the sixth embodiment.

FIG. 19 is a view on arrows C-C of FIGS. 17 and 18.

FIG. 20 is a front view of the electric compressor in the sixth embodiment.

FIG. 21 is a front view of a motor housing in the sixth embodiment.

FIG. 22 is a diagram illustrating a modification of the electric compressor of the sixth embodiment.

### DESCRIPTION OF EMBODIMENTS

Embodiments of the present invention are described hereinafter with reference to the accompanying drawings.

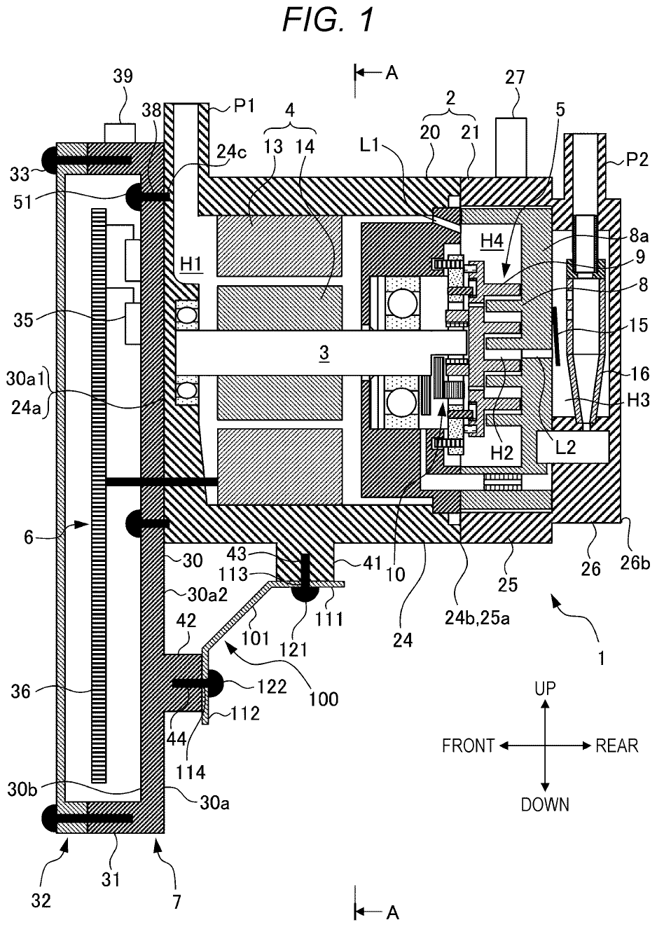

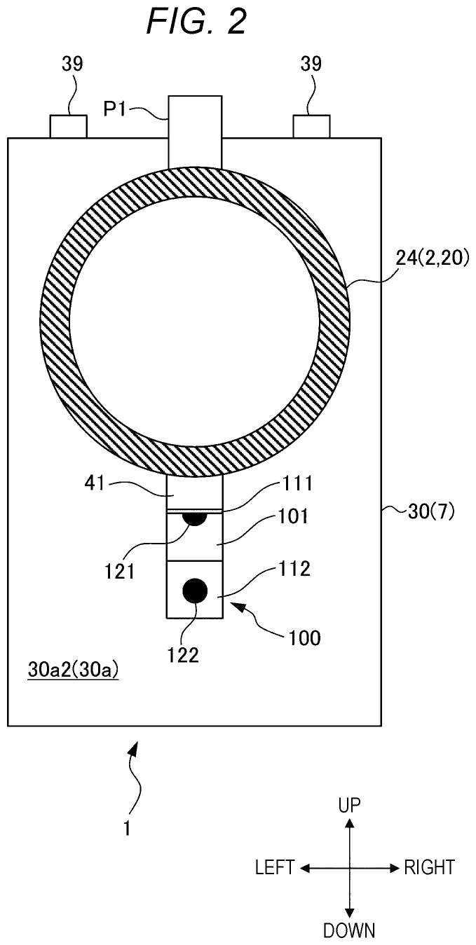

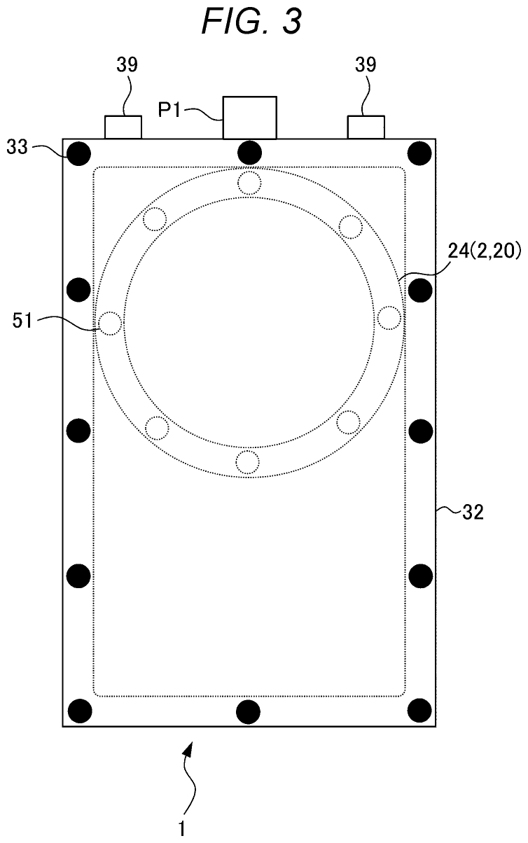

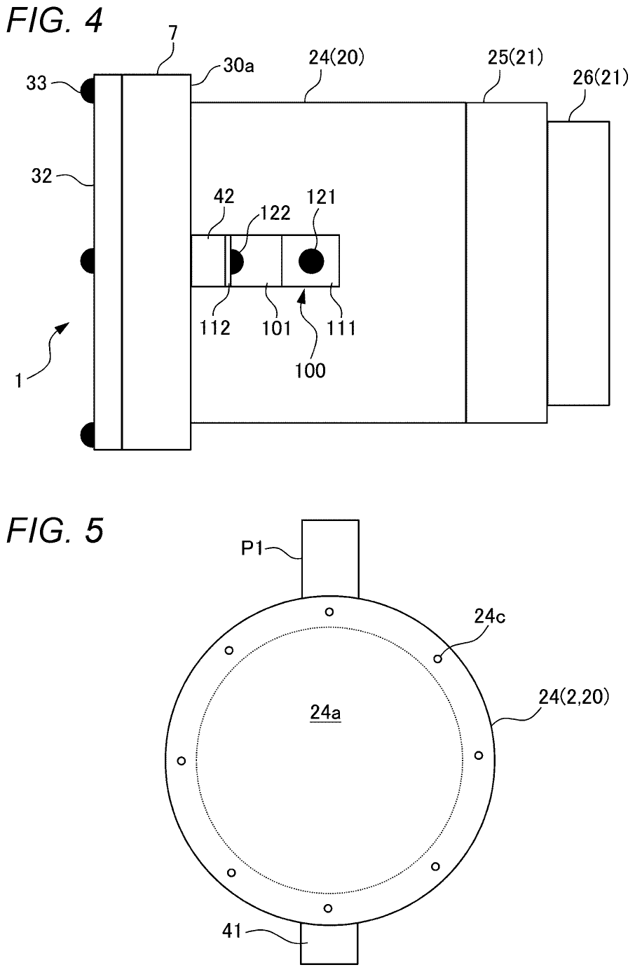

FIG. 1 is a schematic vertical cross-sectional view of an electric compressor 1 in a first embodiment of the present invention. FIG. 2 is a view on arrows A-A of FIG. 1. FIGS. 3 and 4 are a front view and a bottom view of the electric compressor 1, respectively. FIG. 5 is a front view of a motor housing 20. Note that, in FIG. 2, illustrations of components in the motor housing 20 are omitted for simplification of illustration. In the following, front, rear, left, right, up, and down are defined as illustrated in FIGS. 1 and 2 for convenience to described the electric compressor 1.

For example, the electric compressor 1 may be mounted on a vehicle to be a part of a refrigerant circuit of a vehicle air-conditioning apparatus, and may be configured in such a manner as to compress and discharge a refrigerant (a gaseous refrigerant in the embodiment).

The electric compressor 1 includes a housing 2, a rotary shaft 3, an electric motor 4 that rotates the rotary shaft 3, a compression mechanism 5 that is driven by the rotary shaft 3 to compress the refrigerant, an inverter 6 that drives the electric motor 4, and an inverter case 7. The rotary shaft 3, the electric motor 4, and the compression mechanism 5 are accommodated in the housing 2. Here, the electric motor 4 and the compression mechanism 5 are placed in series in an axial direction of the rotary shaft 3 (an axial direction of the electric compressor 1) in the housing 2. The inverter 6 is accommodated in the inverter case 7.

In the embodiment, the electric compressor 1 is an electric scroll compressor, and the compression mechanism 5 is a scroll compression mechanism. The compression mechanism 5 includes a fixed scroll 8 and an orbiting scroll (moving scroll) 9 that performs orbital motion relative to the fixed scroll 8. The fixed scroll 8 and the orbiting scroll 9 are placed, facing each other in the axial direction of the electric compressor 1.

The orbiting scroll 9 is driven by the rotary shaft 3 via a crank mechanism 10, and is configured in such a manner as to perform orbital motion relative to the fixed scroll 8, in other words, revolve around the axis of the fixed scroll 8.

The crank mechanism 10 is configured in such a manner as to couple the rotary shaft 3 and the orbiting scroll 9 and convert the rotational motion of the rotary shaft 3 to the orbital motion of the orbiting scroll 9. The compression mechanism 5 is configured in such a manner as to take in and compress a low-pressure refrigerant by the orbiting scroll 9 performing the orbital motion relative to the fixed scroll 8.

The housing 2 is made of, for example, metal. The housing 2 includes the motor housing 20, which is also referred to as a front housing, and a rear housing 21. The motor housing 20 (a main body portion 24 described below) accommodates the rotary shaft 3 and the electric motor 4. The rear housing 21 (a front tubular portion 25 described below) accommodates the compression mechanism 5. The housing 2 is formed by fastening a rear end surface (a rear end surface 24b described below) of the motor housing 20 to a front end surface (a front end surface 25a described below) of the rear housing 21 with, for example, a fastener of which the illustration is omitted in a state where the rear end surface is in contact with the front end surface.

The main body portion 24 of the motor housing 20 has a tubular shape extending in a front-rear direction (horizontal direction), and particularly has a cylindrical shape in the embodiment. The main body portion 24 has a front end surface (one end surface) 24a that is closed and the rear end surface (the other end surface) 24b that is open.

The rear housing 21 has a tubular shape with two front and rear stages. The rear housing 21 includes the cylindrical front tubular portion 25 having an outer diameter equal to an outer diameter of the main body portion 24 of the motor housing 20, and a cylindrical rear tubular portion 26 having an outer diameter smaller than that of the front tubular portion 25. The front end surface 25a of the front tubular portion 25 is open. A rear end surface 26b of the rear tubular portion 26 is closed. Note that the front tubular portion 25 and the rear tubular portion 26 may be separate members.

The electric motor 4 is formed of, for example, a three-phase synchronous motor (brushless DC motor), and includes a stator core unit 13 and a rotor 14.

The stator core unit 13 is fixed to an inner peripheral surface of the main body portion 24 of the motor housing 20. Direct current from, for example, an unillustrated vehicle-mounted battery is converted by the inverter 6 to three-phase alternating current, and supplied to the stator core unit 13.

The rotor 14 is placed radially inward of the stator core unit 13 with a predetermined spacing therebetween. A permanent magnet (not illustrated) has been integrated in the rotor 14. The rotor 14 is formed in a cylindrical shape, and is fixed to the rotary shaft 3 in a state where the rotary shaft 3 has been inserted through a hollow portion of the rotor 14. In other words, the rotor 14 is integrated with the rotary shaft 3.

When a magnetic field is generated on the stator core unit 13 by the power supplied from the inverter 6 in the electric motor 4, a rotary force acts on the permanent magnet of the rotor 14 to rotate the rotor 14, thereby rotating the rotary shaft 3.

A suction port Pl is formed in an upper part of the main body portion 24 of the motor housing 20 in such a manner as to be adjacent to the front end surface 24a. The suction port Pl is connected to (a low-pressure side of) the refrigerant circuit via, for example, a connecting pipe of which the illustration is omitted.

As illustrated in FIG. 1, in the embodiment, the electric compressor 1 includes a suction chamber H1 into which the low-pressure refrigerant flows, a compression chamber H2 that compresses the low-pressure refrigerant, and a discharge chamber H3 into which the refrigerant compressed in the compression chamber H2 is discharged.

The suction chamber H1 is defined and formed by the main body portion 24 of the motor housing 20. The low-pressure refrigerant from the refrigerant circuit flows into the suction chamber HI through the suction port P1. The low-pressure refrigerant in the suction chamber H1 passes through a refrigerant path L1 and reaches a space H4 in the vicinity of the compression mechanism 5.

The compression chamber H2 is formed in the compression mechanism 5, that is, between the fixed scroll 8 and the orbiting scroll 9. The compression mechanism 5 is configured in such a manner as to compress the low-pressure refrigerant by taking in the low-pressure refrigerant from the space H4 when the compression chamber H2 is formed.

The discharge chamber H3 is placed in the rear tubular portion 26 of the rear housing 21. A discharge hole L2 that causes the compression chamber H2 and the discharge chamber H3 to communicate with each other is formed in a base plate 8a of the fixed scroll 8. Hence, the refrigerant that has been compressed in the compression chamber H2 of the compression mechanism 5 is discharged into the discharge chamber H3 through the discharge hole L2. Note that a check valve 15, such as a reed valve, that allows the flow of the refrigerant from the compression changer H2 to the discharge chamber H3, but regulates the flow of the refrigerant from the discharge chamber H3 to the compression chamber H2 is attached to a surface on a side, which faces the discharge chamber H3, of the base plate 8a of the fixed scroll 8.

An oil separator 16 that separates lubricating oil included in the refrigerant (gaseous refrigerant) is placed in the discharge chamber H3. A discharge port P2 is formed in an upper part of the rear tubular portion 26 of the rear housing 21 in such a manner as to communicate with the discharge chamber H3 (the oil separator 16). The discharge port P2 is connected to (a high-pressure side of) the refrigerant circuit via, for example, a connecting pipe of which the illustration is omitted. Therefore, the lubricating oil is separated by the oil separator 16 from the refrigerant that has flowed into the discharge chamber H3, and then the refrigerant is delivered to the high-pressure side of the refrigerant circuit through the discharge port P2.

Therefore, the low-pressure refrigerant from the refrigerant circuit flows into the suction chamber H1 through the suction port P1, passes through a gap in the electric motor 4, and then is guided to the space H4 in the vicinity of the compression mechanism 5 via the refrigerant path L1. The low-pressure refrigerant that has been guided to the space H4 is taken into the compression chamber H2 of the compression mechanism 5 in step with the orbital motion of the orbiting scroll 9 and is compressed. The refrigerant that has been compressed in the compression chamber H2 is discharged into the discharge chamber H3 through the discharge hole L2 (and the check valve 15), and then the lubricating oil is separated in the oil separator 16. The refrigerant from which the lubricating oil has been separated in the oil separator 16 is then delivered to the refrigerant circuit through the discharge port P2.

Here, the front end surface 24a of the main body portion 24 of the motor housing 20 and the electric motor 4 (the stator core unit 13 and the rotor 14) can be cooled by the low-temperature, low-pressure refrigerant that flows into the suction chamber H1 through the suction port P1. Moreover, the compression mechanism 5 that is driven by the electric motor 4 is configured in such a manner as to compress and discharge the refrigerant that has been sucked into the main body portion 24 (into the suction chamber H1) of the motor housing 20 through the suction port P1.

Note that in the embodiment, one or more projection portions 27 are provided to an upper part of the housing 2 (at least one of an upper part of the motor housing 20 or an upper part of the rear housing 21). The projection portions 27 can be used to fix the housing 2 to the vehicle. The projection portions 27 protrude upward from the upper part of the housing 2 (at least one of the upper part of the motor housing 20 or the upper part of the rear housing 21). The projection portions 27 may have, for example, a rectangular parallelepiped shape (prism shape) or a cylindrical shape.

The inverter case 7 is made of, for example, metal. The inverter case 7 is placed at the front of the main body portion 24 of the motor housing 20. The inverter case 7 abuts on and is fixed to the main body portion 24 of the motor housing 20.

The inverter case 7 includes an end wall (bottom wall) 30, and a peripheral wall 31 that is erected in a peripheral edge portion of the end wall 30 and defines an opening portion facing the end wall 30. In the embodiment, the inverter case 7 has a rectangular box shape extending in an up-down direction, and a rear end portion of the inverter case 7 is formed by the end wall 30. An inverter cover 32 for closing the opening portion is detachably attached to a front end portion of the inverter case 7. A plurality of (12 in the embodiment) bolts 33 is used to fix the inverter cover 32 to the inverter case 7.

The inverter case 7 protrudes upward, downward, leftward, and rightward from the outline of the main body portion 24 of the motor housing 20 as viewed in the axial direction of the electric compressor 1. In the embodiment, the inverter case 7 protrudes greatly downward in particular from the outline of the main body portion 24 of the motor housing 20 as viewed in the axial direction of the electric compressor 1.

An outer surface 30a of the end wall 30 of the inverter case 7 includes an abutment portion 30al that abuts on the front end surface 24a of the main body portion 24 of the motor housing 20, and an exposed portion 30a2 exposed to the outside.

The inverter 6 that is accommodated in the inverter case 7 includes a plurality of (six in the embodiment) switching elements (power switching elements) 35, and a control board 36 on which a control circuit that controls the switching elements 35 is mounted. The control board 36 is placed at a position away from the end wall 30 and toward the opening portion in the inverter case 7. The control board 36 is attached to the inverter case 7 with an unillustrated mounting member. The switching elements 35 are provided to a portion, which is adjacent to the abutment portion 30al (that is, a portion adjacent to the front end surface 24a of the main body portion 24), of an inner surface 30b of the end wall 30 of the inverter case 7.

A plurality of (eight in the embodiment) first bolts 51 is used to fix the inverter case 7 to the main body portion 24 of the motor housing 20. Hence, the end wall 30 of the inverter case 7 is formed with a plurality of (eight in the embodiment) through-holes 38 for inserting male threaded portions of the first bolts 51. Moreover, the main body portion 24 (the front end surface 24a) of the motor housing 20 is formed with a plurality of (eight in the embodiment) female threaded portions 24c with which the male threaded portions of the first bolts 51 are threadedly engaged. Therefore, the first bolts 51 are screwed in from inside the inverter case 7. Here, both of the above-mentioned bolts 33 and first bolts 51 are screwed in from the front toward the rear (that is, in the same direction). Note that in the embodiment, the plurality of (eight in the embodiment) first bolts 51 is aligned, spaced apart from one another, along a circumferential direction of the main body portion 24.

Note that in the embodiment, one or more projection portions 39 are provided to an upper part of the inverter case 7. The projection portions 39 can be used to fix the inverter case 7 to the vehicle. The projection portions 39 protrude upward from the upper part of the inverter case 7. The projection portions 39 may have, for example, a rectangular parallelepiped shape or a cylindrical shape.

In the embodiment, the inverter case 7 protrudes greatly downward from the outline of the main body portion 24 of the motor housing 20 as viewed in the axial direction of the electric compressor 1. Hence, the inverter case 7 is in what is called a cantilevered state. In the embodiment, the motor housing 20 and the inverter case 7 include a first protruding portion 41 and a second protruding portion 42, respectively, to mitigate the cantilevered state.

The first protruding portion 41 is provided to a lower end portion of an outer peripheral surface of the main body portion 24 of the motor housing 20, and protrudes downward from the lower end portion. In other words, the first protruding portion 41 protrudes radially outward from the outer peripheral surface of the main body portion 24 of the motor housing 20. The second protruding portion 42 is provided at a height position lower than the first protruding portion 41, on the exposed portion 30a2 of the outer surface 30a of the end wall 30 of the inverter case 7, and protrudes rearward from the position. In the embodiment, each of the first protruding portion 41 and the second protruding portion 42 has a rectangular parallelepiped shape, but may have a cylindrical shape.

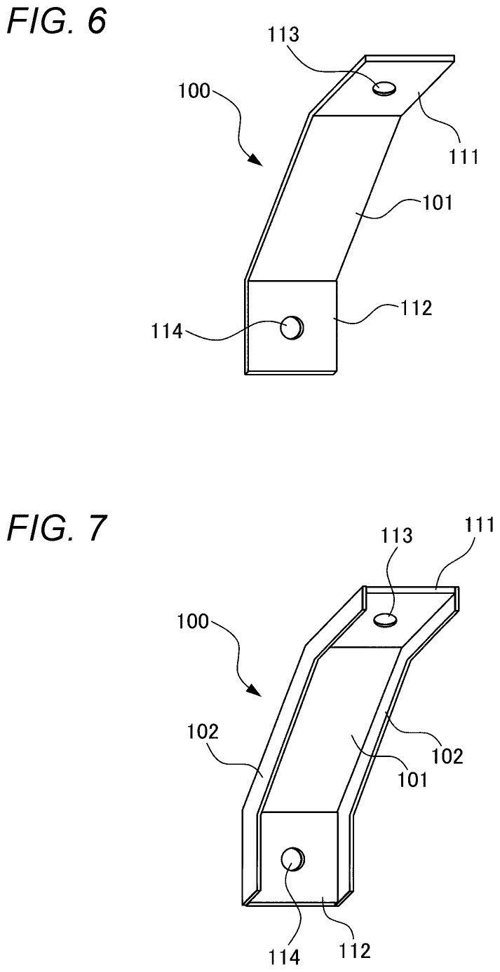

In the embodiment, the first protruding portion 41 is indirectly fixed to the second protruding portion 42 via a coupling member 100. Here, the coupling member 100 is described with reference to FIG. 6 in addition to FIGS. 1 to 5 described above. FIG. 6 is a perspective view of the coupling member 100.

The coupling member 100 includes a rectangular plate-shaped main portion 101 extending in one direction, a rectangular plate-shaped first attachment portion 111 formed at one end portion of the main portion 101, and a rectangular plate-shaped second attachment portion 112 formed at the other end portion of the main portion 101. In the embodiment, the main portion 101, the first attachment portion 111, and the second attachment portion 112 can be formed, for example, by bending one metal plate.

The first attachment portion 111 is in surface contact with a lower end surface of the first protruding portion 41. A bolt 121 is used to fix the first attachment portion 111 to the first protruding portion 41. Hence, a through-hole 113 for inserting a male threaded portion of the bolt 121 is formed in the first attachment portion 111. Note that a female threaded portion 43 with which the male threaded portion of the bolt 121 is threadedly engaged is formed in the first protruding portion 41.

The second attachment portion 112 is in surface contact with a rear end surface of the second protruding portion 42. A bolt 122 is used to fix the second attachment portion 112 to the second protruding portion 42. Hence, a through-hole 114 for inserting a male threaded portion of the bolt 122 is formed in the second attachment portion 112. Note that a female threaded portion 44 with which the male threaded portion of the bolt 122 is threadedly engaged is formed in the second protruding portion 42.

In the embodiment, on the basis of a perspective of the mitigation of the above-mentioned cantilevered state of the inverter case 7, it is preferable that the second protruding portion 42 be provided at a position as far downward as possible from the first protruding portion 41. Moreover, in order to use a plurality of the coupling members 100, it is needless to say that the first protruding portion 41 and the second protruding portion 42 may be provided for each of the coupling members 100. In other words, the electric compressor 1 may include a plurality of the coupling members 100, a plurality of the first protruding portions 41, and a plurality of second protruding portions 42.

According to the embodiment, the electric compressor 1 includes the electric motor 4, the compression mechanism 5 that is driven by the electric motor 4, the inverter 6 that drives the electric motor 4, the motor housing 20 that accommodates the electric motor 4, and the inverter case 7 that abuts on and is fixed to the motor housing 20, and accommodates the inverter 6. The motor housing 20 includes the tubular main body portion 24, and the first protruding portion 41 provided on the outer peripheral surface of the main body portion 24. The inverter case 7 includes the end wall 30, and the outer surface 30a of the end wall 30 includes the abutment portion 30al that abuts on the front end surface 24a (the one end surface) of the main body portion 24, and the exposed portion 30a2 exposed to the outside. The exposed portion 30a2 of the outer surface 30a of the end wall 30 is provided with the second protruding portion 42. The first protruding portion 41 is indirectly fixed to the second protruding portion 42 via the coupling member 100. Consequently, it is possible to suppress occurrence of resonance in the inverter case 7 during operation of the electric compressor 1. Note that it is preferable that at least one of the first protruding portion 41 or the second protruding portion 42 have a rectangular parallelepiped shape or a cylindrical shape.

Moreover, according to the embodiment, the coupling member 100 includes the first attachment portion 111 in surface contact with the first protruding portion 41 and the second attachment portion 112 in surface contact with the second protruding portion 42. The first attachment portion 111 is fixed to the first protruding portion 41. The second attachment portion 112 is fixed to the second protruding portion 42. Consequently, the coupling member 100 can be formed with a simple structure.

Moreover, according to the embodiment, the suction port P1 is formed in the main body portion 24 in such a manner as to be adjacent to the front end surface 24a (the one end surface). The compression mechanism 5 is configured in such a manner as to compress and discharge the refrigerant that has been sucked into the main body portion 24 through the suction port P1. The switching elements 35 included in the inverter 6 are provided to the portion adjacent to the abutment portion 30al on the inner surface 30b of the end wall 30. Therefore, the switching elements 35 can be cooled via the front end surface 24a of the main body portion 24 and the end wall 30 of the inverter case 7, by the low-temperature, low-pressure refrigerant flowing into the main body portion 24 through the suction port P1.

Moreover, according to the embodiment, the electric compressor 1 is mounted on the vehicle. The main body portion 24 extends in the horizontal direction. The inverter case 7 extends in the up-down direction. The upper part of the inverter case 7 is provided with the projection portions 39 for fixing to the vehicle. The inverter case 7 protrudes downward of the main body portion 24. In addition, the first protruding portion 41 is provided to the lower end portion of the outer peripheral surface of the main body portion 24. The second protruding portion 42 is provided at the height position lower than the first protruding portion 41, on the exposed portion 30a2 of the outer surface 30a of the end wall 30. Consequently, it is possible to encourage the mitigation of the above-mentioned cantilevered state of the inverter case 7. Here, the main body portion 24 has a cylindrical shape, and the first protruding portion 41 protrudes radially outward from the outer peripheral surface of the main body portion 24.

Next, a second embodiment of the present invention is described with reference to FIG. 7. FIG. 7 is a perspective view of the coupling member 100 in the embodiment. Differences from the above-mentioned first embodiment are described.

In the embodiment, the coupling member 100 further includes a pair of left and right reinforcing portions 102. Each of the reinforcing portions 102 is provided on an inner side toward which the coupling member 100 (the main portion 101, the first attachment portion 111, and the second attachment portion 112) is bent, in such a manner as to suppress deformation of the bent coupling member 100 (the main portion 101, the first attachment portion 111, and the second attachment portion 112). The reinforcing portions 102 are erected at both left and right edge portions of each of the main portion 101, the first attachment portion 111, and the second attachment portion 112, which make up the coupling member 100.

In particular, according to the embodiment, the coupling member 100 further includes the pair of left and right reinforcing portions 102. Consequently, the stiffness of the coupling member 100 can be increased, which in turn enables further suppressing the occurrence of resonance in the inverter case 7 during the operation of the electric compressor 1.

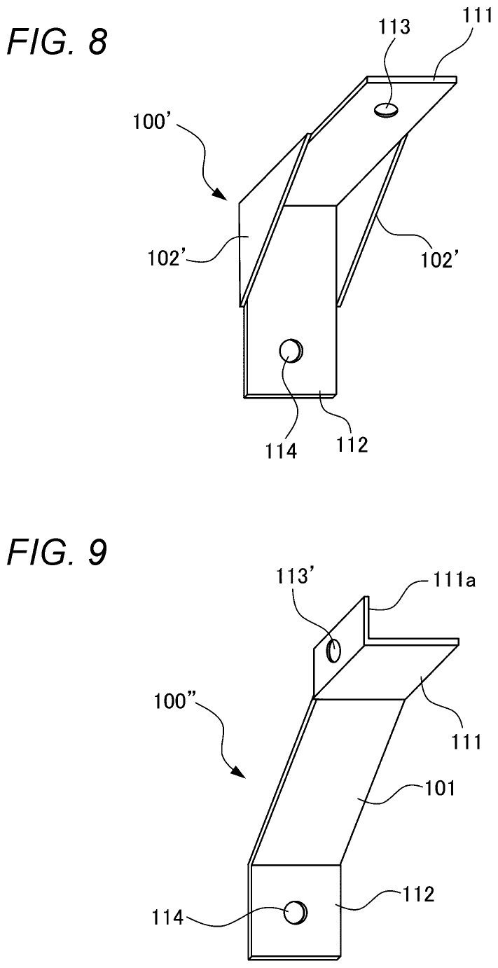

Next, a third embodiment of the present invention is described with reference to FIG. 8. FIG. 8 is a perspective view of a coupling member 100′ in the embodiment. Differences from the above-mentioned first embodiment are described.

In the coupling member 100′ in the embodiment, the above-mentioned main portion 101 is omitted and, for example, one metal plate is bent at a right angle to form the first attachment portion 111 and the second attachment portion 112. A pair of left and right reinforcing portions 102′ is provided to a corner portion which is a coupling portion between the first attachment portion 111 and the second attachment portion 112. Each of the reinforcing portions 102′ is fixed to the above-mentioned corner portion by, for example, welding in such a manner as to suppress deformation of the coupling member 100′ (the first attachment portion 111 and the second attachment portion 112) that is bent at the right angle.

In particular, according to the embodiment, the coupling member 100′ further includes the pair of left and right reinforcing portions 102′. Consequently, the stiffness of the coupling member 100′ can be increased, which in turn enables further suppressing the occurrence of resonance in the inverter case 7 during the operation of the electric compressor 1.

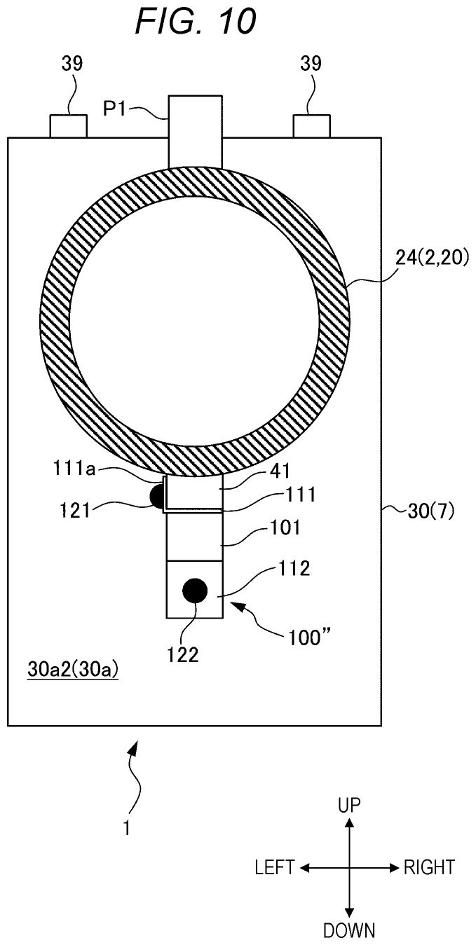

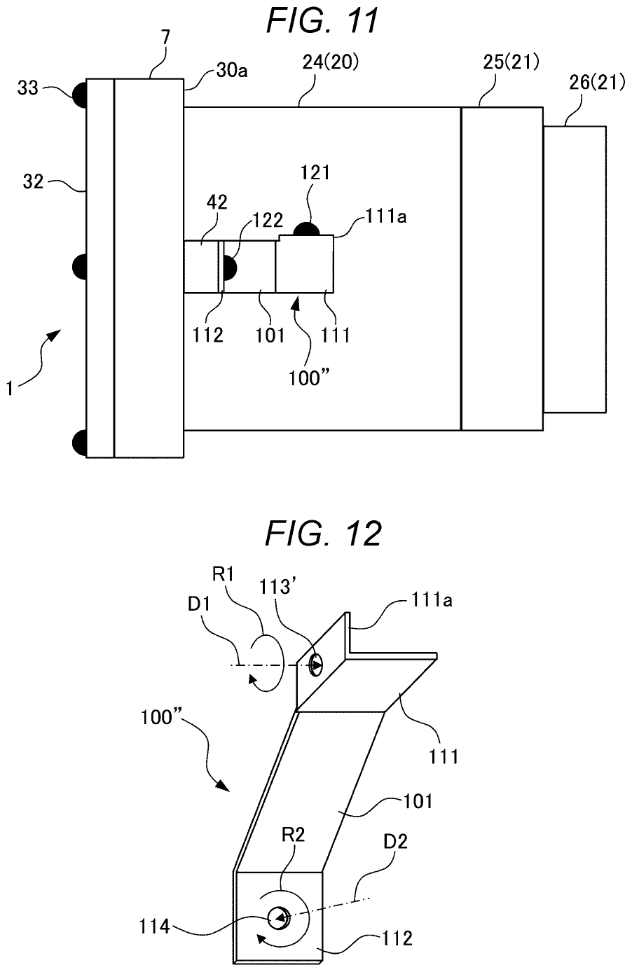

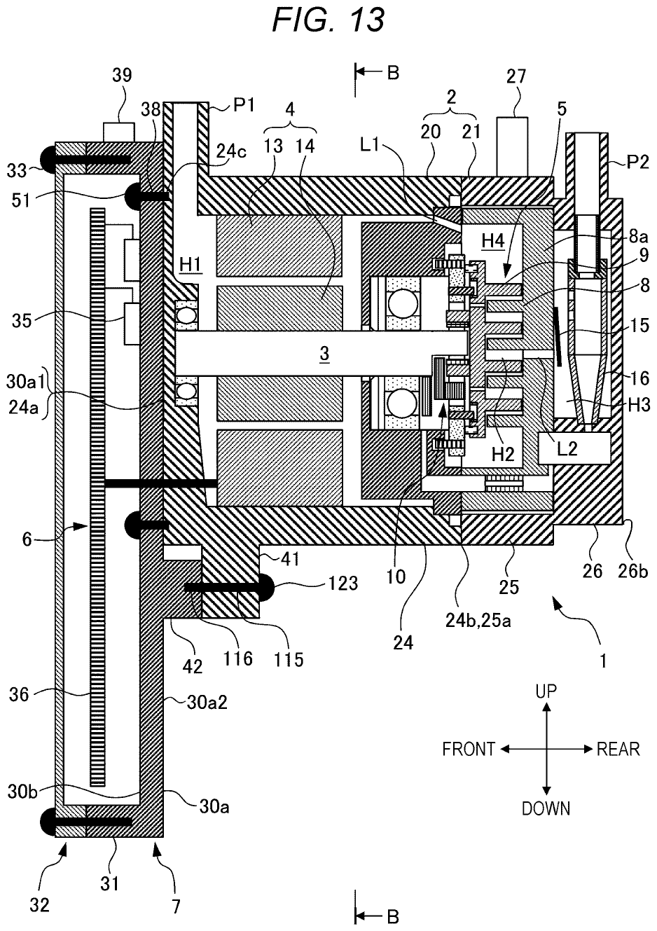

Next, a fourth embodiment of the present invention is described with reference to FIGS. 9 to 12. FIG. 9 is a perspective view of a coupling member 100″ in the embodiment. FIG. 10 is a diagram illustrating an attached state of the coupling member 100″ as viewed from the rear in the embodiment. FIG. 11 is a diagram illustrating the attached state of the coupling member 100″ as viewed from below in the embodiment. FIG. 12 is a diagram for explaining a rotation stop function of the coupling member 100″ in the embodiment. Here, FIG. 10 corresponds to FIG. 2 described above. Differences from the above-mentioned first embodiment are described.

In the coupling member 100″ in the embodiment, the first attachment portion 111 of the above-mentioned coupling member 100 is provided with a rectangular plate-shaped extension portion 111a that is in surface contact with a left side surface of the first protruding portion 41. In addition, a through-hole 113′ for inserting the male threaded portion of the bolt 121 is formed in the extension portion 111a of the first attachment portion 111. Note that a female threaded portion (not illustrated) with which the male threaded portion of the bolt 121 is threadedly engaged is formed in the first protruding portion 41.

In the embodiment, the bolt 121 is screwed in from the left to the right. On the other hand, the bolt 122 is screwed in from the rear to the front. In this regard, FIG. 12 illustrates a screwing direction D1 of the bolt 121, a rotation direction R1 of the bolt 121 for screwing the bolt 121, a screwing direction D2 of the bolt 122, and a rotation direction R2 of the bolt 122 for screwing the bolt 122.

When the bolt 121 is screwed in the screwing direction D1 (that is, from the left to the right), the bolt 121 rotates clockwise (along the rotation direction R1). With the rotation, the coupling member 100″ also attempts to rotate clockwise (along the rotation direction R1), but this rotation is prevented by the second attachment portion 112 that is in surface contact with the second protruding portion 42. In other words, the second attachment portion 112 functions as a rotation stopper that suppresses rotation of the coupling member 100″ relative to the first protruding portion 41 at the time of fastening with the bolt 121.

On the other hand, when the bolt 122 is screwed in the screwing direction D2 (that is, from the rear to the front), the bolt 122 rotates clockwise (along the rotation direction R2). With the rotation, the coupling member 100″ also attempts to rotate clockwise (along the rotation direction R2), but this rotation is prevented by the extension portion 111a of the first attachment portion 111 that is in surface contact with the first protruding portion 41. In other words, the extension portion 111a of the first attachment portion 111 functions as a rotation stopper that suppresses the rotation of the coupling member 100″ relative to the second protruding portion 42 at the time of fastening with the bolt 122.

In particular, according to the embodiment, the fixing of the first attachment portion 111 (the extension portion 111a) to the first protruding portion 41 and the fixing of the second attachment portion 112 to the second protruding portion 42 are performed by bolt fastening with the bolts 121 and 122, respectively. The first attachment portion 111 (the extension portion 111a) and the second attachment portion 112 are configured in such a manner as to function as the rotation stoppers that suppress the rotation of the coupling member 100″ relative to the first protruding portion 41 and the second protruding portion 42 at the time of fastening with the bolts 121 and 122, respectively. Consequently, the assembly operation of the coupling member 100″ can be efficiently performed.

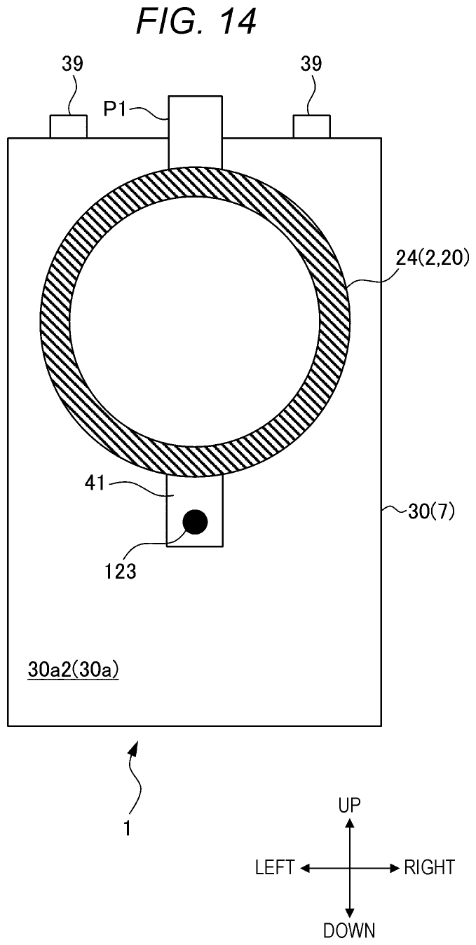

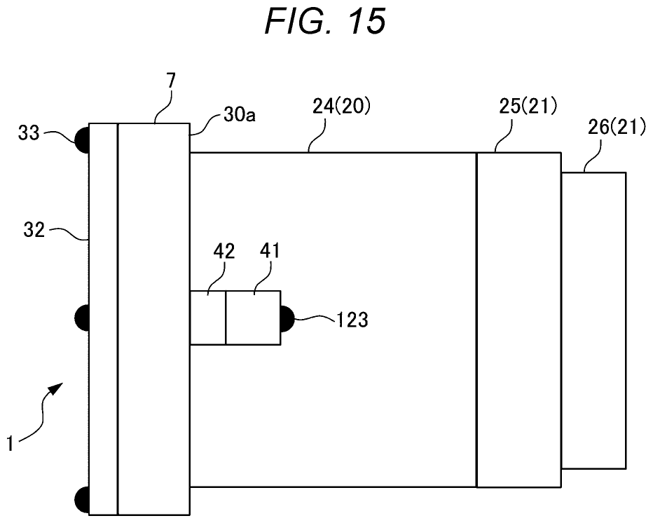

Next, a fifth embodiment of the present invention is described with reference to FIGS. 13 to 15. FIG. 13 is a schematic vertical cross-sectional view of the electric compressor 1 in the embodiment. FIG. 14 is a view on arrows B-B of FIG. 13. FIG. 15 is a bottom view of the electric compressor 1 in the embodiment. Note that, in FIG. 13, illustrations of components in the motor housing 20 are omitted for simplification of illustration as in FIG. 2. Differences from the above-mentioned first embodiment are described.

In the embodiment, the second protruding portion 42 is provided at a height position equal to the first protruding portion 41, on the exposed portion 30a2 of the outer surface 30a of the end wall 30 of the inverter case 7, and protrudes rearward from the position. In addition, the first protruding portion 41 is directly fixed to the second protruding portion 42 with a bolt 123 in a state where a front end surface of the first protruding portion 41 abuts on the rear end surface of the second protruding portion 42. Hence, a through-hole 115 for inserting a male threaded portion of the bolt 123 is formed in the first protruding portion 41. Moreover, a female threaded portion 116 with which the male threaded portion of the bolt 123 is threadedly engaged is formed in the second protruding portion 42. Therefore, the bolt 123 is screwed in from the rear to the front.

In particular, according to the embodiment, the first protruding portion 41 abuts on the second protruding portion 42. In addition, the first protruding portion 41 is directly fixed to the second protruding portion 42 with the bolt 123. Consequently, the above-mentioned coupling members 100, 100′ and 100″ can be omitted.

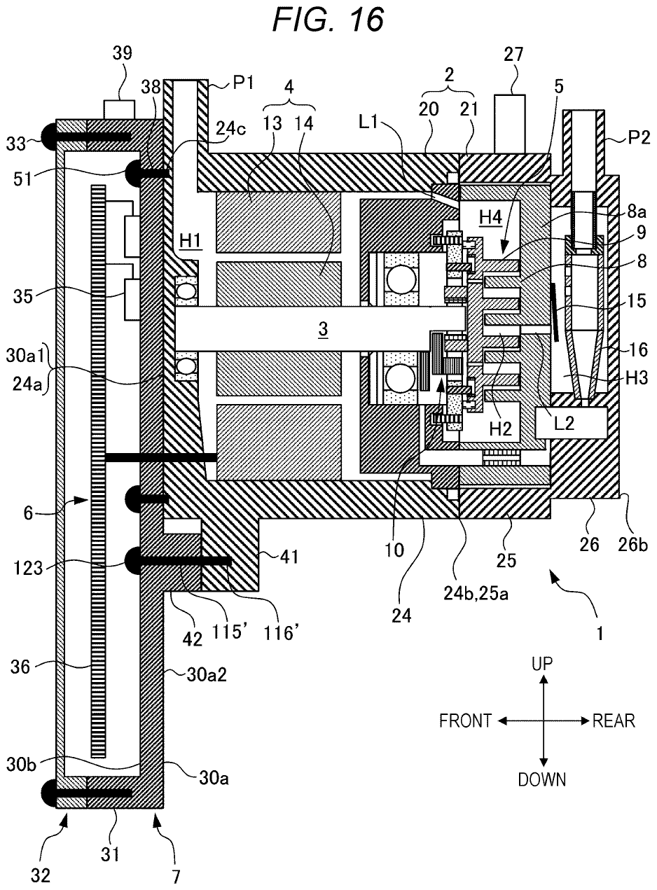

FIG. 16 is a diagram illustrating a modification of the electric compressor 1 of the embodiment. In the modification, a through-hole 115′ for inserting the male threaded portion of the bolt 123 is formed in the end wall 30 and the second protruding portion 42 of the inverter case 7. Moreover, a female threaded portion 116′ with which the male threaded portion of the bolt 123 is threadedly engaged is formed in the first protruding portion 41. Therefore, the bolt 123 is screwed in from inside the inverter case 7. Moreover, as described above, the first bolts 51 are also screwed in from inside the inverter case 7. Furthermore, both of the bolt 123 and the first bolts 51 are screwed in from the front to the rear (that is, in the same direction). Therefore, the screwing operation of the bolt 123 and the screwing operation of the first bolts 51 can be performed in a series of operations.

Examples of clauses (clauses) that can be grasped from the above-mentioned first to fifth embodiments and modification thereof are described below.

### Clause 1

An electric compressor including:
an electric motor;
a compression mechanism configured to be driven by the electric motor;
an inverter configured to drive the electric motor;
a motor housing configured to accommodate the electric motor; and
an inverter case abutting on and fixed to the motor housing, the inverter case being configured to accommodate the inverter, in which
the motor housing includes a tubular main body portion, and a first protruding portion provided on an outer peripheral surface of the main body portion,
the inverter case includes an end wall, and an outer surface of the end wall includes an abutment portion that abuts on one end surface of the main body portion, and an exposed portion exposed to the outside,
the exposed portion of the outer surface of the end wall is provided with a second protruding portion, and
the first protruding portion is directly or indirectly fixed to the second protruding portion.

### Clause 2

The electric compressor according to clause 1, in which
the first protruding portion abuts on the second protruding portion, and
the first protruding portion is directly fixed to the second protruding portion with a bolt.

### Clause 3

The electric compressor according to clause 1, in which the first protruding portion is indirectly fixed to the second protruding portion via a coupling member.

### Clause 4

The electric compressor according to clause 3, in which
the coupling member includes a first attachment portion in surface contact with the first protruding portion, and a second attachment portion in surface contact with the second protruding portion,
the first attachment portion is fixed to the first protruding portion, and
the second attachment portion is fixed to the second protruding portion.

### Clause 5

The electric compressor according to clause 4, in which
the fixing of the first attachment portion to the first protruding portion and the fixing of the second attachment portion to the second protruding portion are performed by bolt fastening, and
the first attachment portion and the second attachment portion are configured to function as rotation stoppers that suppress rotation of the coupling member relative to the first protruding portion and the second protruding portion upon fastening with the bolts, respectively.

### Clause 6

The electric compressor according to clause 4 or 5, in which the coupling member further includes a reinforcing portion.

### Clause 7

The electric compressor according to any of clauses 1 to 6, in which
the main body portion is formed with a suction port in such a manner that the suction port is adjacent to the end surface,
the compression mechanism is configured to compress and discharge a refrigerant sucked into the main body portion through the suction port, and
a switching element included in the inverter is provided to a portion, which is adjacent to the abutment portion, on an inner surface of the end wall.

### Clause 8

The electric compressor according to any of clauses 1 to 7, in which
the electric compressor is mounted on a vehicle,
the main body portion extends in a horizontal direction,
the inverter case extends in an up-down direction,
an upper part of the inverter case is provided with a projection portion for fixing to the vehicle, and
the inverter case protrudes downward of the main body portion.

### Clause 9

The electric compressor according to clause 8, in which
the first protruding portion is provided to a lower end portion of the outer peripheral surface of the main body portion, and
the second protruding portion is provided at a height position equal to or lower than the first protruding portion, on the exposed portion of the outer surface of the end wall.

### Clause 10

The electric compressor according to any of clauses 1 to 9, in which
the main body portion has a cylindrical shape, and
the first protruding portion protrudes radially outward from the outer peripheral surface of the main body portion.

### Clause 11

The electric compressor according to any of clauses 1 to 10, in which at least one of the first protruding portion or the second protruding portion has a rectangular parallelepiped shape or a cylindrical shape.

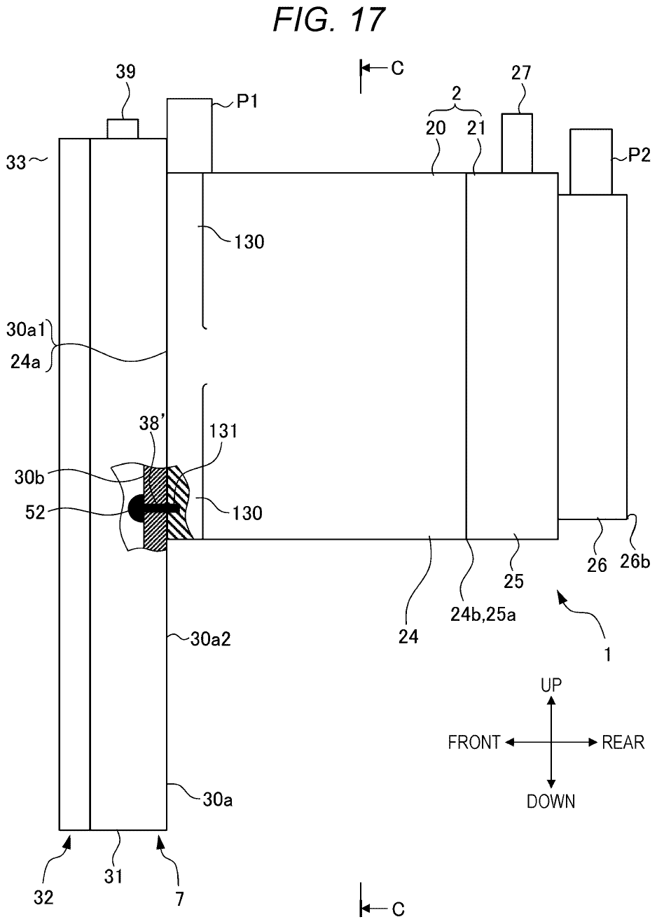

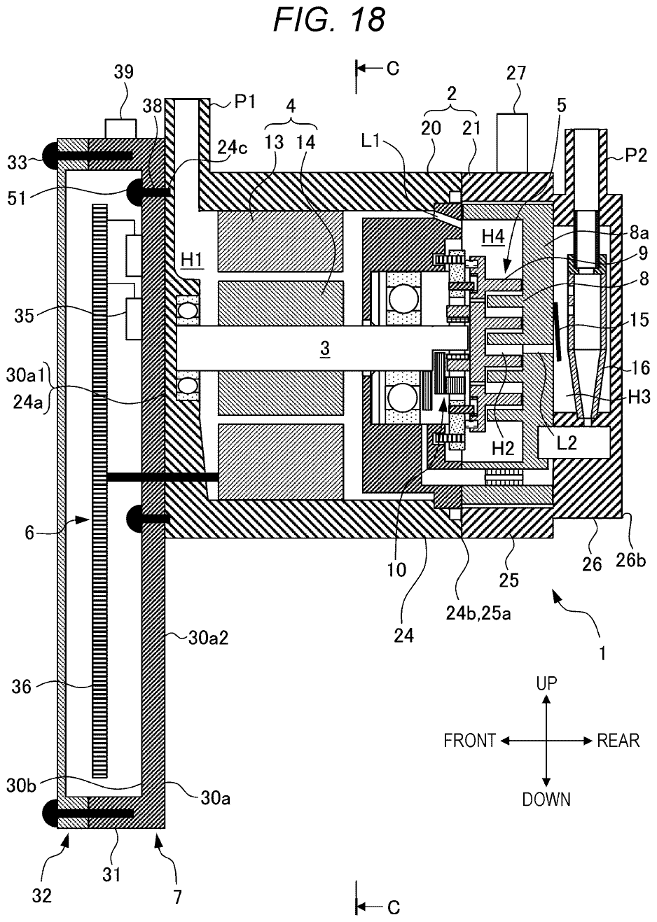

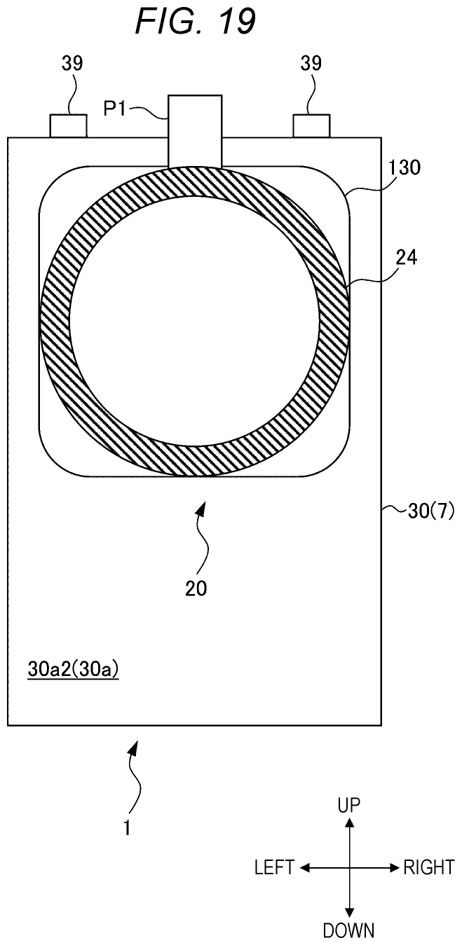

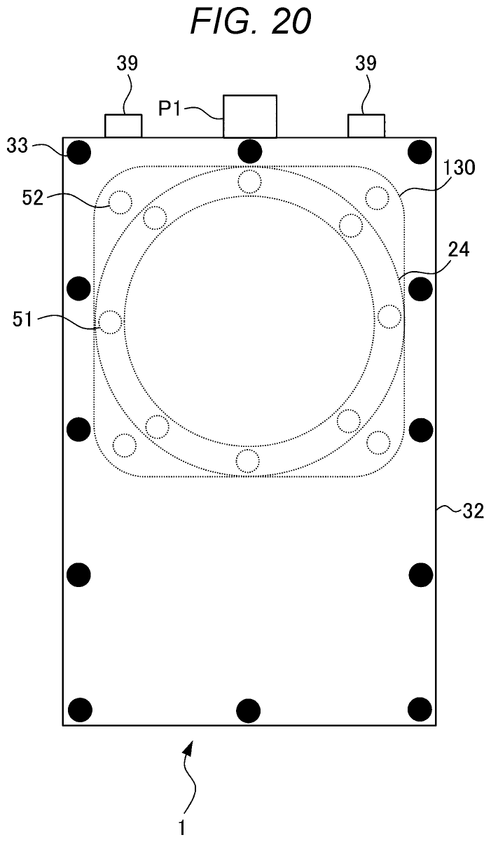

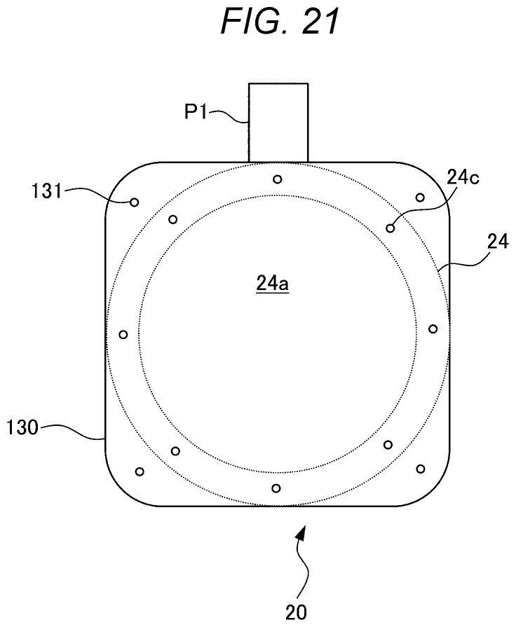

Next, a sixth embodiment of the present invention is described with reference to FIGS. 17 to 21. FIG. 17 is a left side view of the electric compressor 1 in the embodiment. FIG. 18 is a schematic vertical cross-sectional view of the electric compressor 1 in the embodiment. FIG. 19 is a view on arrows C-C of FIGS. 17 and 18. FIG. 20 is a front view of the electric compressor 1 in the embodiment. FIG. 21 is a front view of the motor housing 20 in the embodiment. Note that in FIG. 17, a partial cross section in an attachment place of a second bolt 52 described below is also illustrated. Moreover, in FIG. 19, illustrations of components in the motor housing 20 are omitted for simplification of illustration as in FIG. 2. Differences from the above-mentioned first embodiment are described.

In the embodiment, the above-mentioned first protruding portion 41 and second protruding portion 42 are omitted. The motor housing 20 includes a flange portion 130 in addition to the above-mentioned main body portion 24. The flange portion 130 is formed on the front end surface (one end surface) 24a of the main body portion 24. The flange portion 130 protrudes radially outward from the front end surface 24a of the main body portion 24. The flange portion 130 has a square outline that surrounds the outer peripheral surface of the main body portion 24 from the outside as viewed in the axial direction of the electric compressor 1. It is preferable that the outer peripheral surface of the main body portion 24 be inscribed in the square outline of the flange portion 130 as viewed in the axial direction of the electric compressor 1. Consequently, it is possible to minimize the protrusion of the flange portion 130 from the outer peripheral surface of the main body portion 24.

In the embodiment, the front end surface 24a of the main body portion 24 and the flange portion 130 of the motor housing 20 abut on the outer surface 30a of the end wall 30 of the inverter case 7. In the embodiment, the inverter case 7 protrudes upward, downward, leftward, and rightward from the outline of the flange portion 130 of the motor housing 20 as viewed in the axial direction of the electric compressor 1.

In the embodiment, a plurality of (four in the embodiment) the second bolts 52 is used to fix the inverter case 7 to the flange portion 130 of the motor housing 20. Hence, the end wall 30 of the inverter case 7 is formed with a plurality of (four in the embodiment) through-holes 38′ for inserting male threaded portions of the second bolts 52. Moreover, the flange portion 130 of the motor housing 20 is formed with a plurality of (four in the embodiment) female threaded portions 131 with which the male threaded portions of the second bolts 52 are threadedly engaged. Therefore, the second bolts 52 are screwed in from inside the inverter case 7. Moreover, as described above, the first bolts 51 are also screwed in from inside the inverter case 7.

Furthermore, both of the first bolts 51 and the second bolts 52 are screwed in from the front to the rear (that is, in the same direction). Therefore, the screwing operation of the first bolts 51 and the screwing operation of the second bolts 52 can be performed in a series of operations. Note that in the embodiment, the second bolts 52 are placed at four corners of the flange portion 130 having the square outline, respectively.

In particular, according to the embodiment, the electric compressor 1 includes the electric motor 4, the compression mechanism 5 that is driven by the electric motor 4, the inverter 6 that drives the electric motor 4, the motor housing 20 that accommodates the electric motor 4, the inverter case 7 that accommodates the inverter 6, and at least one first bolt 51 and at least one second bolt 52 for fixing the inverter case 7 to the motor housing 20 with the inverter case 7 abutting on the motor housing 20. The motor housing 20 includes the tubular main body portion 24, and the flange portion 130 formed on the front end surface 24a (the one end surface) of the main body portion 24. The front end surface 24a of the main body portion 24 and the flange portion 130 abut on the inverter case 7. The first bolt 51 fixes the inverter case 7 to the main body portion 24. The second bolt 52 fixes the inverter case 7 to the flange portion 130.

Consequently, it is possible to suppress occurrence of resonance in the inverter case 7 during operation of the electric compressor 1.

Moreover, according to the embodiment, the main body portion 24 has a cylindrical shape, and the flange portion 130 protrudes radially outward from the front end surface 24a (the one end surface) of the main body portion 24. Consequently, the contact area of the motor housing 20 with the inverter case 7 can be increased with a simple structure, and they can be fastened to each other with the bolts at multiple points.

Moreover, according to the embodiment, the inverter case 7 includes the end wall 30, and the outer surface 30a of the end wall 30 abuts on the front end surface 24a (the one end surface) of the main body portion 24 and the flange portion 130. The end wall 30 is formed with at least one through-hole 38. The main body portion 24 (the front end surface 24a) is formed with at least one female threaded portion 24c. The male threaded portion of the first bolt 51 is inserted through the through-hole 38 in the end wall 30 and threadedly engaged with the female threaded portion 24c. Consequently, the first bolt 51 can be screwed in from inside the inverter case 7.

Moreover, according to the embodiment, the inverter case 7 includes the end wall 30, and the outer surface 30a of the end wall 30 abuts on the front end surface 24a (the one end surface) of the main body portion 24 and the flange portion 130. The end wall 30 is formed with at least one through-hole 38′. The flange portion 130 is formed with at least one female threaded portion 131. The male threaded portion of the second bolt 52 is inserted through the through-hole 38′ in the end wall 30 and threadedly engaged with the female threaded portion 131 of the flange portion 130. Consequently, the second bolt 52 can be screwed in from inside the inverter case 7.

Moreover, according to the embodiment, the suction port P1 is formed in the main body portion 24 in such a manner as to be adjacent to the front end surface 24a (the one end surface). The compression mechanism 5 is configured in such a manner as to compress and discharge the refrigerant that has been sucked into the main body portion 24 through the suction port P1. The inverter case 7 includes the end wall 30, and the outer surface 30a of the end wall 30 abuts on the front end surface 24a of the main body portion 24 and the flange portion 130. The switching elements 35 included in the inverter 6 are provided to the portion, which is adjacent to the front end surface 24a of the main body portion 24, on the inner surface 30b of the end wall 30. Therefore, the switching elements 35 can be cooled via the front end surface 24a of the main body portion 24 and the end wall 30 of the inverter case 7, by the low-temperature, low-pressure refrigerant flowing into the main body portion 24 through the suction port P1.

Moreover, according to the embodiment, the electric compressor 1 is mounted on the vehicle. The main body portion 24 extends in the horizontal direction. The inverter case 7 extends in the up-down direction. The upper part of the inverter case 7 is provided with the projection portions 39 for fixing to the vehicle. The inverter case 7 protrudes downward of the main body portion 24. In the electric compressor 1 in such a form, it is possible to suppress the occurrence of resonance in the inverter case 7 during the operation of the electric compressor 1.

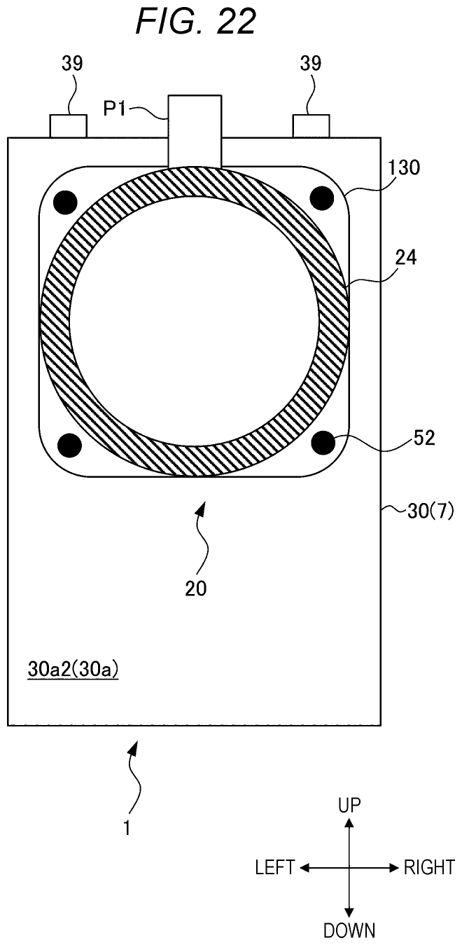

FIG. 22 is a diagram illustrating a modification of the electric compressor 1 of the embodiment, and corresponds to FIG. 19 described above. In the modification, the flange portion 130 is formed with a plurality of (four in the modification) through-holes (not illustrated). Moreover, the end wall 30 of the inverter case 7 is formed with a plurality of (four in the modification) female threaded portions (not illustrated). In addition, the male threaded portions of the second bolts 52 are inserted through the through-holes of the flange portion 130 and threadedly engaged with the female threaded portions of the end wall 30 of the inverter case 7. Therefore, the second bolts 52 are screwed in from the rear to the front.

Examples of clauses that can be grasped from the above-mentioned sixth embodiment and modification thereof are described below.

### Clause 12

An electric compressor including:
an electric motor;
a compression mechanism configured to be driven by the electric motor;
an inverter configured to drive the electric motor;
a motor housing configured to accommodate the electric motor;
an inverter case configured to accommodate the inverter; and
at least one first bolt and at least one second bolt for fixing the inverter case to the motor housing with the inverter case abutting on the motor housing, in which
the motor housing includes a tubular main body portion, and a flange portion formed on one end surface of the main body portion,
the end surface of the main body portion and the flange portion abut on the inverter case,
the first bolt fixes the inverter case to the main body portion, and
the second bolt fixes the inverter case to the flange portion.

### Clause 13

The electric compressor according to clause 12, in which
the main body portion has a cylindrical shape, and
the flange portion protrudes radially outward from the end surface of the main body portion.

### Clause 14

The electric compressor according to clause 12 or 13, in which
the inverter case includes an end wall, and an outer surface of the end wall abuts on the end surface of the main body portion and the flange portion,
the end wall is formed with at least one through-hole,
the flange portion is formed with at least one female threaded portion, and
a male threaded portion of the second bolt is inserted through the through-hole of the end wall, and is threadedly engaged with the female threaded portion of the flange portion.

### Clause 15

The electric compressor according to any of clauses 12 to 14, in which
the main body portion is formed with a suction port in such a manner that the suction port is adjacent to the end surface, and
the compression mechanism is configured to compress and discharge a refrigerant sucked into the main body portion through the suction port,
the inverter case includes the end wall, and the outer surface of the end wall abuts on the end surface of the main body portion and the flange portion, and
a switching element included in the inverter is provided to a portion, which is adjacent to the end surface of the main body portion, of an inner surface of the end wall.

### Clause 16

The electric compressor according to any of clauses 12 to 15, in which
the electric compressor is mounted on a vehicle,
the main body portion extends in a horizontal direction,
the inverter case extends in an up-down direction,
an upper part of the inverter case is provided with a projection portion for fixing to the vehicle, and
the inverter case protrudes downward of the main body portion.

It is needless to say that the method for fixing the inverter case 7 and the flange portion 130 of the motor housing 20 by use of at least one second bolt 52, which has been described in the above-mentioned sixth embodiment and modification thereof, can be applied to the electric compressor 1 described in the above-mentioned first to fifth embodiments and modifications thereof.

In the above-mentioned first to sixth embodiments and modifications thereof, the plurality of first bolts 51 is used to fix the inverter case 7 and the main body portion 24 of the motor housing 20. In this regard, long bolts may be used as some of the plurality of first bolts 51 to collectively fix the inverter cover 32, the inverter case 7, and the main body portion 24 of the motor housing 20. Consequently, some of the plurality of bolts 33 can be omitted.

In the above-mentioned sixth embodiment and modifications thereof, the plurality of second bolts 52 is used to fix the inverter case 7 and the flange portion 130 of the motor housing 20. In this regard, long bolts may be used as some of the plurality of second bolts 52 to collectively fix the inverter cover 32, the inverter case 7, and the flange portion 130 of the motor housing 20. Consequently, some of the plurality of bolts 33 can be omitted.

In the above-mentioned first to sixth embodiments and modifications thereof, front, rear, left, right, up, and down relative to the electric compressor 1 are defined as described above for convenience of description. However, this is not intended to limit the directionality of the electric compressor 1. In other words, in the above-mentioned first to sixth embodiments and modifications thereof, the electric compressor 1 is a horizontal electric compressor in which the electric motor 4 and the compression mechanism 5 are placed in series in the horizontal direction in the housing 2, but may be a vertical electric compressor in which the electric motor 4 and the compression mechanism 5 are placed in series in the vertical direction in the housing 2.

In the above-mentioned first to sixth embodiments and modifications thereof, the electric compressor 1 is a scroll compressor, but the electric compressor 1 is not limited to the scroll compressor. The electric compressor 1 may be, for example, what is called a swash plate compressor.

Up to this point the embodiments of the present invention and the modifications thereof have been described above. However, the present invention is not limited to the above-mentioned embodiments and modifications, and as a matter of course, the present invention can be modified further on the basis of the technical idea of the present invention.

### LIST OF REFERENCE SIGNS

1 Electric compressor
2 Housing
3 Rotary shaft
4 Electric motor
5 Compression mechanism
6 Inverter
7 Inverter case
8 Fixed scroll
8a Base plate
9 Orbiting scroll
10 Crank mechanism
13 Stator core unit
14 Rotor
15 Check valve
16 Oil separator
20 Motor housing
21 Rear housing
24 Main body portion
24a Front end surface
24b Rear end surface
24c Female threaded portion
25 Front tubular portion
25a Front end surface
26 Rear tubular portion
26b Rear end surface
27 Projection portion
30 End wall
30a Outer surface
30al Abutment portion
30a2 Exposed portion
30b Inner surface
31 Peripheral wall
32 Inverter cover
33 Bolt
35 Switching element
36 Control board
38, 38′ Through-hole
39 Projection portion
41 First protruding portion
42 Second protruding portion
43, 44 Female threaded portion
51 First bolt
52 Second bolt
100, 100′, 100″ Coupling member
101 Main portion
102, 102′ Reinforcing portion
111 First attachment portion
111a Extension portion
112 Second attachment portion
113, 113′, 114, 115, 115′ Through-hole
116, 116′ Female threaded portion
121, 122, 123 Bolt
130 Flange portion
131 Female threaded portion
D1, D2 Screwing direction
H1 Suction chamber
H2 Compression chamber
H3 Discharge Chamber
H4 Space
L1 Refrigerant path
L2 Discharge hole
P1 Suction port
P2 Discharge port
R1, R2 Rotation direction

1. An electric compressor comprising:
an electric motor;
a compression mechanism configured to be driven by the electric motor;
an inverter configured to drive the electric motor;
a motor housing configured to accommodate the electric motor; and
an inverter case abutting on and fixed to the motor housing, the inverter case being configured to accommodate the inverter, wherein
the motor housing includes a tubular main body portion, and a first protruding portion provided on an outer peripheral surface of the main body portion,
the inverter case includes an end wall, and an outer surface of the end wall includes an abutment portion that abuts on one end surface of the main body portion, and an exposed portion exposed to the outside,
the exposed portion of the outer surface of the end wall is provided with a second protruding portion, and
the first protruding portion is directly or indirectly fixed to the second protruding portion.

2. The electric compressor according to claim 1, wherein
the first protruding portion abuts on the second protruding portion, and
the first protruding portion is directly fixed to the second protruding portion with a bolt.

3. The electric compressor according to claim 1, wherein the first protruding portion is indirectly fixed to the second protruding portion via a coupling member.

4. The electric compressor according to claim 3, wherein
the coupling member includes a first attachment portion in surface contact with the first protruding portion, and a second attachment portion in surface contact with the second protruding portion,
the first attachment portion is fixed to the first protruding portion, and
the second attachment portion is fixed to the second protruding portion.

5. The electric compressor according to claim 4, wherein
the fixing of the first attachment portion to the first protruding portion and the fixing of the second attachment portion to the second protruding portion are performed by bolt fastening, and
the first attachment portion and the second attachment portion are configured to function as rotation stoppers that suppress rotation of the coupling member relative to the first protruding portion and the second protruding portion upon fastening with the bolts, respectively.

6. The electric compressor according to claim 4, wherein the coupling member further includes a reinforcing portion.

7. The electric compressor according to claim 1, wherein
the main body portion is formed with a suction port in such a manner that the suction port is adjacent to the end surface,
the compression mechanism is configured to compress and discharge a refrigerant sucked into the main body portion through the suction port, and
a switching element included in the inverter is provided to a portion, which is adjacent to the abutment portion, on an inner surface of the end wall.

8. The electric compressor according to claim 1, wherein
the electric compressor is mounted on a vehicle,
the main body portion extends in a horizontal direction,
the inverter case extends in an up-down direction,
an upper part of the inverter case is provided with a projection portion for fixing to the vehicle, and
the inverter case protrudes downward of the main body portion.

9. The electric compressor according to claim 8, wherein
the first protruding portion is provided to a lower end portion of the outer peripheral surface of the main body portion, and
the second protruding portion is provided at a height position equal to or lower than the first protruding portion, on the exposed portion of the outer surface of the end wall.
